(19) United States
(12) Patent Application Publication
(10) Pub. No.: US 2019/0005699 A1
(43) Pub. Date: Jan. 3, 2019

(54) TECHNOLOGIES FOR GENERATING A MOTION MODEL FOR A VIRTUAL CHARACTER

(71) Applicant: Intel Corporation, Santa Clara, CA (US)

(72) Inventor: Glen J. Anderson, Beaverton, OR (US)

(21) Appl. No.: 15/638,796

(22) Filed: Jun. 30, 2017

(51) Int. Cl. G06T 13/40; G06T 7/246

(52) U.S. Cl. CPC G06T 13/40; G06F 17/30864; G06T 2207/10016; G06T 7/251

(57) ABSTRACT

Technologies for generating a motion model for a virtual character includes a compute device that generates an online search query for motion videos of an animal that depict a corresponding animal in motion and selects a motion video from a search result of the online search query. The selected motion video is analyzed to generate a motion model for the virtual character based on the motion of the animal depicted in the selected motion video. The compute device presents the virtual character in motion on a display using the generated motion model for the motion of the virtual character.

### BACKGROUND

Virtual video systems allow users to create and interact with virtual characters, which may represent physical objects in some cases. For example, users may create a virtual video game based on virtual characters or a virtual story video based on the physical objects associated with virtual characters. Typically, the virtual video systems include predefined motion models for a particular virtual character or type of character. The predefined motion model may define, for example, how the virtual character moves, interacts with the virtual environment, and/or other actions of the virtual character. In typical virtual video systems, the user is limited to the selection of the predetermined motion models. Alternatively, the user may create a custom motion model from scratch, but such an endeavor can be arduous and overly complex for the typical user.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for generating a motion model for a virtual character;

FIG. 2 is a simplified block diagram of at least one embodiment of a process flow of the generation of a motion model that may be performed by the system of FIG. 1;

FIG. 3 is a simplified block diagram of at least one embodiment of an environment that may be established by a compute device of FIG. 1; and

FIGS. 4 and 5 are a simplified flow diagram of at least one embodiment of a method for generating a motion model for a virtual character that may be executed by the compute device of FIGS. 1 and 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

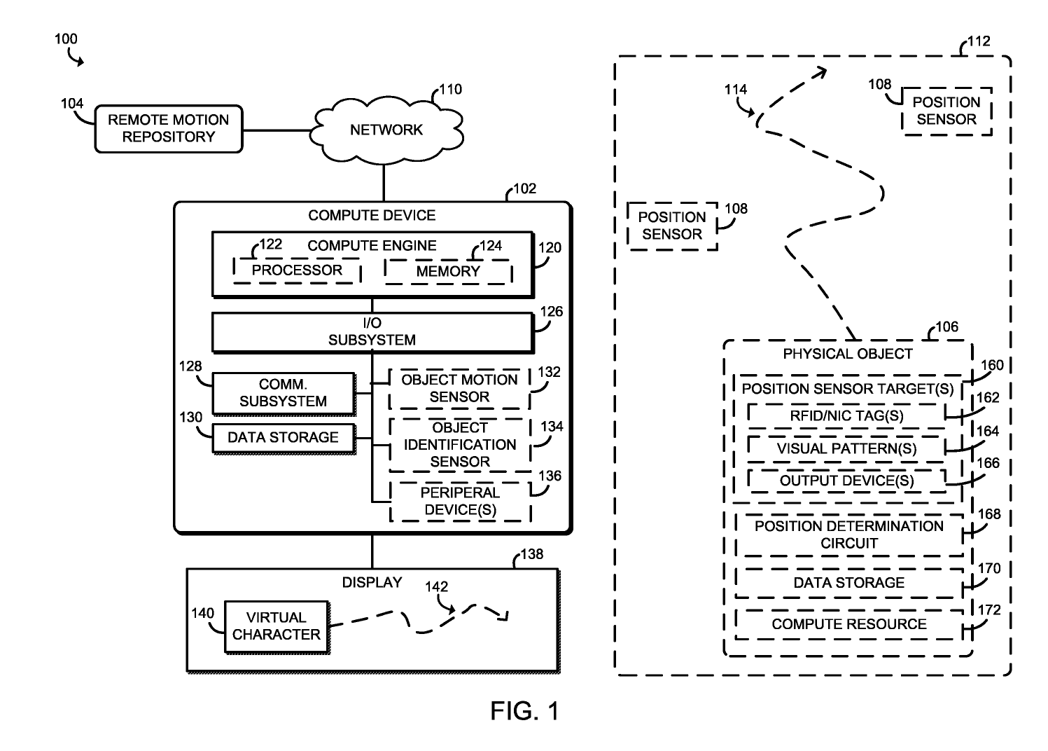

Referring now to FIG. 1, in an illustrative embodiment, a system 100 for generating a motion model for a virtual character 140 includes a compute device 102 that communicates with a remote motion repository 104 over a network 110 to search for one or more motion videos from which to generate the motion model. The motion videos may be embodied as any type of video that captures the motion of a corresponding animal (e.g., the depicts the animal walking, running, jumping, or otherwise moving). In use, as discussed in more detail below, the compute device 102 is configured to query the remote motion repository 104 for the motion videos to generate a motion model for the virtual character 140 based on the motion of the animal depicted in the motion video. It should be appreciated that the online search query for the motion videos may be generated based on a user input, the virtual character 140, and/or the identification of a physical object 106 associated with the virtual character 140. Additionally or alternatively, characteristics of the motion of the virtual character 140 and/or the physical object 106 may be used to search for a motion video that matches the motion characteristics. For examples, the characteristics of the motion of the virtual character 140 and/or the physical object 106 may include, but not limited to, a relative speed, an orientation, a position, an angle, different kinds of actions, animal sounds, environmental or background sounds, visual aspects such as color scheme, or age of animal. Once a motion video is selected, the compute device 102 generates a motion model for the motion of the animal by generating a virtual rigging for the animal that matches the motion of the animal as depicted in the corresponding motion video. The animal's motion model is used to generate a new motion model for the virtual character 140 by applying the animal's motion model to the virtual rigging of the virtual character 140 such that the virtual character 140 mimics the motion (e.g., the limb movements and posturing) of the animal depicted in the motion video.

For example, in some embodiments, the user (e.g., a child) may select a virtual character 140 (e.g., a dinosaur) in a virtual environment, and the compute device 102 generates a virtual rigging for the selected virtual character 140. The user may then draw a virtual motion path 142 in a virtual environment for the virtual character 140 and query the remote motion repository 104 for one or more motion videos that includes an animal (e.g., a monkey) associated with the virtual character 140. The compute device 102 may analyze the motion video result to generate a motion model for a motion of the animal depicted in the motion video and apply the motion model to the virtual rigging of the virtual character 140 to mimic the limb movements and posturing of the animal (e.g., a dinosaur to walk like a monkey) along the virtual motion path 142 as discussed in more detail below.

In other embodiments, the virtual character 140 may be associated with a physical object 106 positioned in a physical environment 112. In such embodiments, a user (e.g., a child) may physically move the physical object 106 (e.g., a toy) along a motion path 114. In such embodiments, the compute device 102 may generate a virtual character 140 (e.g., a dinosaur) associated with the physical object 106 and generate a virtual rigging for the virtual character 140. The compute device 102 may perform the similar operations discussed above to generate an online search query for motion video of an animal selected by the user or that corresponds to the physical object 106 and generate a motion model of the animal depicted in the motion video to apply to the virtual character 140. The system 100 that includes the physical object 106 in the physical environment 112 further allows the user to create a video of a virtual scene with custom movements using the physical object 106.

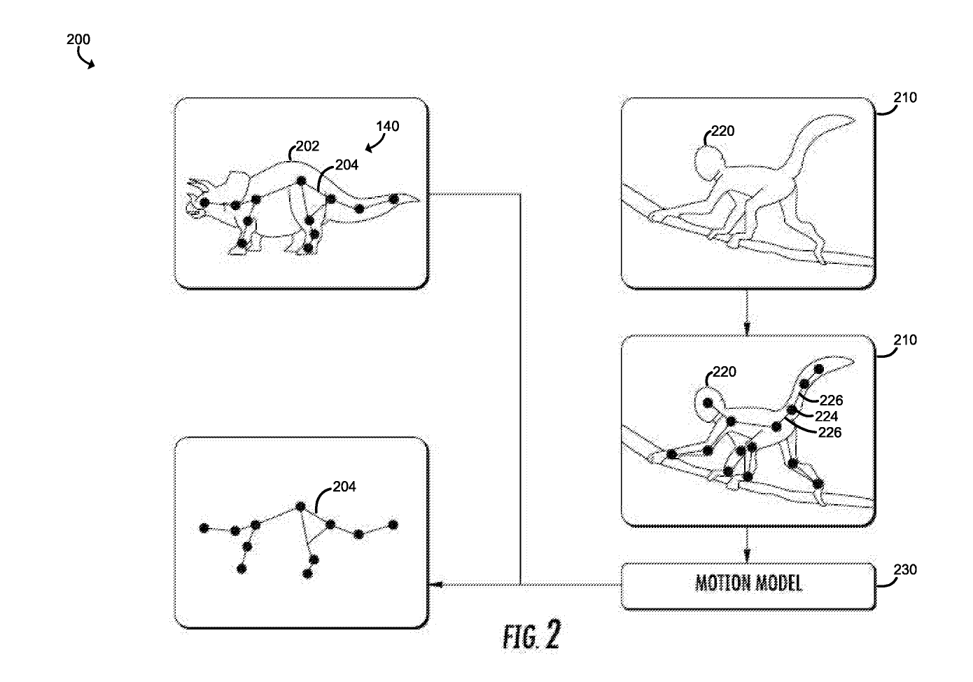

Referring now to FIG. 2, an illustrative embodiment of a process flow 200 of the generation of a motion model for a virtual character is shown. In the illustrative embodiment, the user has selected or otherwise generated a virtual character 140 embodied as a virtual dinosaur 202, which is displayed on a display 138 of the compute device 102. While the virtual dinosaur 202 may have canned or predetermined motion model associated therewith that depicts how that particular virtual dinosaur 202 is to move on the display 138, the user may generate other motion models based on the motion of other animals using the technologies described herein. To do so, in the illustrative embodiment, the user has instructed the compute device 102 to generate a search for motion videos of a monkey. One search result is a motion video 210 that shows a monkey 220 climbing a tree branch. The user decides to use the motion of the monkey 220 climbing the tree branch as the motion for the virtual dinosaur 202. As such, the compute device 102 generates and applies a virtual rigging 222 for the monkey 220, which is overlaid onto the monkey 220. Depending on the particular implementation (e.g., the granularity or accuracy of the mimicked movement), the virtual rigging 222 may be simplistic or complex and have various characteristics. For example, in the illustrative embodiment, the virtual rigging is embodied as a set of joints 224 and associated bones or rigs 226 connected to the joints 224, which may pivot relative to the joints 224. However, in other embodiments, other types of riggings may be used. For example, in three-dimensional embodiments, a three-dimensional mesh rigging may be used. Regardless, after the virtual rigging 222 has been determined, a motion model 230 is generated based on the movement of the virtual rigging 222 as the monkey 220 moves in the motion video 210. That is, the motion model 230 causes the virtual rigging 222 to match the movements of the monkey 220. The motion model 230 is subsequently applied to a virtual rigging 204 of the virtual dinosaur 200 to cause the virtual rigging 204, and thereby the virtual dinosaur 200 to move in a manner that mimics the movement of the monkey 220 in the motion video 210. A motion model for the virtual dinosaur 202 based on the motion model 230 and the virtual riggings 204 may be generated such that the virtual dinosaur 202 can be moved along a desired path determined by the user. Examples of methods for generating a rigging of for motion depicted in an image or video are provided in C. H. Lim, E. Vats, C. S. Chan. Fuzzy human motion analysis: a review. Pattern Recogn., 48(5)(2015), pp. 1773-1796; and Wampler et al. Generalizing locomotion style to new animals with inverse optimal regression. ACM Transactions on Graphics (TOG)—Proceedings of ACM SIGGRAPH 2014 TOG Homepage, Volume 33 Issue 4, July 2014, Article No. 49.

Referring back to FIG. 1, the compute device 102 may be embodied as any type of computation or computer device capable of performing the functions described herein, including, without limitation, a computer, a laptop computer, a notebook computer, a tablet computer, a mobile phone, a smart phone, a wearable compute device, a network appliance, a web appliance, a distributed computing system, a processor-based system, and/or a consumer electronic device. As shown in FIG. 1, the compute device 102 illustratively includes a compute engine 120 that includes a processor 122 and a memory 124, an input/output subsystem 126, and a communication subsystem 128, and a data storage device 130. In embodiments in which the compute device 102 is configured to generate a motion model for a virtual character 140 that is associated with a physical object 106, the compute device 102 may include an object motion sensor 132 and an object identification sensor 134 as discussed in detail below. It should be appreciated that the compute device 102 may include other or additional components, such as those commonly found in a computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 122 in some embodiments.

The processor 122 may be embodied as any type of processor capable of performing the functions described herein. The processor 122 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the compute device 102 such as operating systems, applications, programs, libraries, and drivers. The memory 124 is communicatively coupled to the processor 122 via the I/O subsystem 126, which may be embodied as circuitry and/or components to facilitate input/output operations with the processor 122, the memory 124, and other components of the compute device 102. For example, the I/O subsystem 126 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 126 may form a portion of a system-on-a-chip (SoC) and be incorporated, along with the processors 122, the memory 124, and other components of the compute device 102, on a single integrated circuit chip.

The communication subsystem 128 of the compute device 102 may be embodied as any communication circuit, device, or collection thereof, capable of enabling communications between the compute device 102, a display 138 coupled to the compute device 102, the physical object 106, the remote motion repository 104, and/or other remote devices over a network. The communication subsystem 128 may be configured to use any one or more communication technology (e.g., wired or wireless communications) and associated protocols (e.g., 3G, LTE, Ethernet, Bluetooth®, Wi-Fi®, WiMAX, etc.) to effect such communication. The data storage device 130 may be embodied as any type of device or devices configured for short-term or long-term storage of data such as, for example, memory devices and circuits, memory cards, hard disk drives, solid-state drives, or other data storage devices.

The compute device 102 may also include any number of additional input/output devices, interface devices, and/or other peripheral devices. For example, in some embodiments, the peripheral devices may include a touch screen, graphics circuitry, keyboard, mouse, speaker system, network interface, and/or other input/output devices, interface devices, and/or peripheral devices 136.

The network 110 may be embodied as any type of network capable of facilitating communications between the compute device 102 and the remote motion repository 104. For example, the network 110 may be embodied as, or otherwise include, a wireless local area network (LAN), a wireless wide area network (WAN), a cellular network, and/or a publicly-accessible, global network such as the Internet. As such, the network 110 may include any number of additional devices, such as additional computers, routers, and switches, to facilitate communications thereacross.

The remote motion repository 104 may be embodied as any collection of motion videos. In some embodiments, the remote motion repository 104 may be embodied as a single server that stores and manages motion videos. In other embodiments, the remote motion repository 104 may be embodied as a collection of separate data servers that together form a motion repository. Additionally, the remote motion repository 104 may include its own online search engine frontend that is capable of receiving an online search query directly from the compute device 102. In other embodiments, the remote motion repository 104 may be embodied as a public search engine that searches data repositories of motion videos in response to a query from the compute device 102.

In the illustrative embodiment, the display 138 is coupled to the compute device 102 to display the virtual character 140 in the virtual environment. Additionally, in some embodiments, the display 138 may be used to display one or more motion videos from the remote motion repository 104 for a user's selection. The display 138 may be embodied as any type of display capable of displaying digital information such as a liquid crystal display (LCD), a light emitting diode (LED), a plasma display, a cathode ray tube (CRT), or other type of display device. In some embodiments, the display 138 may be coupled to, or incorporated with, a touch screen to allow user interaction with the compute device 102. For example, the touch screen may be used to receive one or more user selections such as selecting a virtual character 140 associated with a physical object 106, an animal that corresponds to the virtual character 140, an animal that corresponds to the physical object 106, and/or a motion video to be used to generate a motion model to be applied to the virtual character 140. Although shown as separate from the compute device 102 in FIG. 1, it should be appreciated that the display 138 may be may be incorporated in, or otherwise form a portion of, the compute device 102 in other embodiments.

As discussed above, in some embodiments, the virtual character 140 may correspond to a physical object 106 that is configured to be identified and tracked in a physical environment 112 (e.g., as a user moves the physical object 106 in the physical environment 112). In such embodiments, the compute device 102 may further include the object identification sensor 134 and the object identification sensor 134. The object motion sensor 132 may be embodied as any type sensor or sensors configured to track a motion of the physical object 106 and determine characteristics of the motion. For example, in some embodiments, the object motion sensor 132 may be embodied as one or more position sensors. The position sensors may be embodied as one or more electronic circuits or other devices capable of determining the position of the physical object 106 to track a motion path and determine characteristics of the motion of the physical object 106. For example, the position sensors may be embodied as or otherwise include one or more radio frequency identifier (RFID) and/or near-field communication (NFC) antennas that are capable of interrogating and identifying RFID tags included in the physical object 106. In that example, the compute device 102 may include or otherwise be coupled to an array of RFID/NFC antennas capable of determining the relative positions of nearby physical object 106, such as a sensor mat that includes the array of RFID/NFC antennas. Additionally or alternatively, in some embodiments the position sensors may include proximity sensors, Reed switches, or any other sensor capable of detecting the position and/or proximity of the physical object 106. In some embodiments, the position sensors may be capable of detecting signals emitted by the physical object 106, such sensors capable of detecting infrared (IR) light emitted by one or more IR LEDs of the physical object 106, microphones capable of detecting sound emitted by the physical object 106, or other sensors. As shown in FIG. 1, in some embodiments, additional position sensors may be positioned in the physical environment 112 near the physical object 106 to track the physical object 106.

In some embodiments, the object motion sensor 132 may include a camera to track the motion of the physical object 106 and determine characteristics of the motion. The camera may be embodied as a digital camera or other digital imaging device integrated with the compute device 102 or otherwise communicatively coupled thereto. The camera includes an electronic image sensor, such as an active-pixel sensor (APS), e.g., a complementary metal-oxide-semiconductor (CMOS) sensor, or a charge-coupled device (CCD). The camera may be used to capture image data including, in some embodiments, capturing still images or video images. Similarly, the audio sensor may be embodied as any sensor capable of capturing audio signals such as one or more microphones, a line input jack and associated circuitry, an analog-to-digital converter (ADC), or other type of audio sensor. The camera and the audio sensor may be used together to capture video of the environment of the compute device 102, including the physical object 106.

Additionally or alternatively, in some embodiments, radio strength and/or direction capabilities, such as those available in Bluetooth® Low Energy, may be used to determine the position of the physical object 106. In the embodiment in which there are more than one physical objects 106 being tracked, proximity sensing may occur between physical objects 106, for example, each physical object 106 may include a proximity sensing sensor. In other embodiments, sensing may occur through a surface on which the physical object 106 sit. For example, the surface may include an array of NFC antennas that can track the identity and location of NFC tags, thus identifying the location of associated physical object 106 on the surface.

The object identification sensor 134 may be embodied as any type sensor or sensors configured to determine an identification of the physical object 106. The identification of the physical object 106 may be used determine a virtual character 140 and/or an animal associated with the physical object 106. To do so, in some embodiments, the object identification sensor 134 may include a camera to detect a visual pattern of the physical object 106 to identify the physical object 106. In some embodiments, other components of the compute device 102, such as the communication subsystem 128, may be used to determine the identity of the physical object 106. For example, as discussed below, the physical object 106 may store identity information (e.g., the identification of the physical object 106, the associated virtual character 140, and/or the associated animal), which may be communicated to the compute device 102.

The physical object 106 is configured to facilitate its position being detected by the compute device 102, as described further herein. The physical object 106 may be embodied as any object capable of performing the functions described herein including, without limitation, a toy, a toy figure, a toy playset, a token, an embedded compute device, a mobile compute device, a wearable compute device, and/or a consumer electronic device. As such, the physical object 106 may include one or more position sensor targets 160. The position sensor targets 160 may be embodied as any circuitry, antenna, device, physical feature, or other aspect of the physical object 106 that may be detected by the position sensors 108 of the compute device 102. For example, as shown, the position sensor targets 160 may include one or more RFID/NFC tags 162, one or more visual patterns 164, and/or one or more output devices 166. The visual patterns 164 may be detected, for example, by the object motion sensor 132 and/or the object identification sensor 134 of the compute device 102. The output devices 166 may include any device that generates a signal that may be detected by the compute device 102. For example, the output devices 166 may be embodied as one or more visible light and/or IR LEDs, a speaker, or other output device.

In some embodiments, the physical object 106 may include a position determiner circuit 168 that may determine the position of the physical object 106 to track a motion path 114 of the physical object 106. In some embodiments, the position determiner circuit 168 may further determine characteristics of a motion of the physical object 106 as the physical object 106 moves along the motion path 114. As discussed in detail below, the characteristics of the motion of the physical object 106 may be considered when determining an animal associated with the physical object 106, generating an online search query for motion videos of an animal, and/or refining or filtering motion video search results.

In some embodiments, physical object 106 may include a data storage 170, which may store data identifying properties of the physical object 106. For example, the data may identify a character the physical object 106 represents, which may be used by the compute device to generate a virtual character 140 that matches the character identified by the data. In such embodiments, the physical object 106 may or may not resemble the virtual character. For example, physical object 106 may be embodied as simple cube or cylinder piece, but have identification data stored in the data storage 170 that identifies the physical object as an airplane. In such embodiments, the physical object 106 may transmit the identification data to the compute device 102 to allow the compute device 102 to generate a virtual character 140 that resembles an airplane.

Additionally, the physical object 106 may also include compute resources 172, such as processing resources (i.e., a microcontroller), memory resources, user input resources, and/or communication resources. For example, in some embodiments the compute resources 172 may include a processor, an I/O subsystem, a memory, a data storage device, a communication subsystem, and/or peripheral devices. Those individual components of the physical object 106 may be similar to the corresponding components of the compute device 102, the description of which is applicable to the corresponding components of the physical object 106 and is not repeated herein so as not to obscure the present disclosure. In particular, in some embodiments, the physical object 106 may include user input devices such as motion sensors (e.g., accelerometers and/or gyroscopes), touch sensors (e.g., capacitive or resistive touch sensors, force sensors, or other touch sensors), input buttons, or other input devices. In some embodiments, the physical object 106 may include one or more object motion sensor(s). It should be appreciated that, in some embodiments the physical object 106 may not include any compute resources other than passive position sensor targets 160. For example, the physical object 106 may be embodied as toys including one or more RFID/NFC tags.

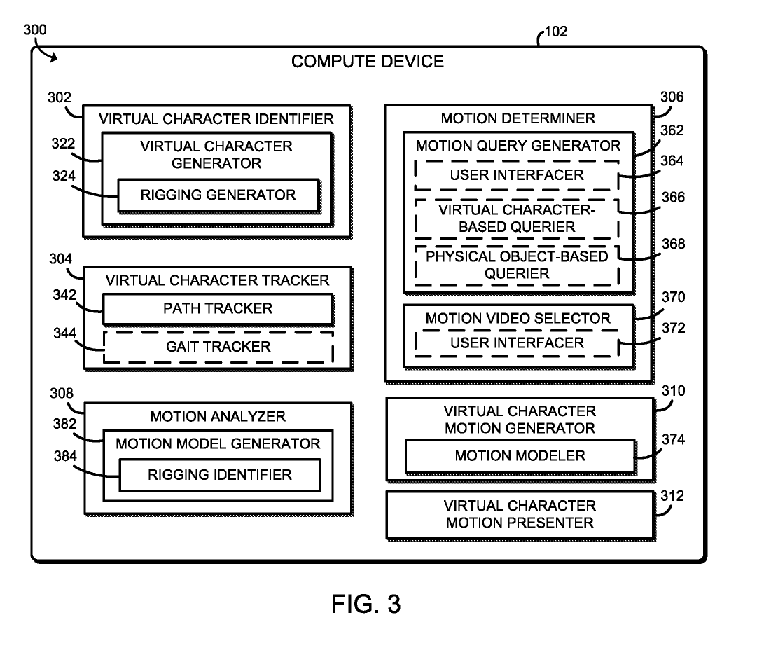

Referring now to FIG. 3, in an illustrative embodiment, the compute device 102 establishes an environment 300 during operation. The illustrative environment 300 includes a virtual character identifier 302, a virtual character tracker 304, a motion determiner 306, a motion analyzer 308, a virtual character motion generator 310, and a virtual character motion presenter 312. The various modules of the environment 300 may be embodied as hardware, firmware, software, or a combination thereof. As such, in some embodiments, one or more of the modules of the environment 300 may be embodied as circuitry or collection of electrical devices (e.g., virtual character identifier circuitry 302, virtual character tracker circuitry 304, motion determiner circuitry 306, motion analyzer circuitry 308, virtual character motion generator circuitry 310, virtual character motion presenter circuitry 312, etc.). It should be appreciated that, in such embodiments, one or more of the virtual character identifier circuitry 302, the virtual character tracker circuitry 304, the motion determiner circuitry 306, the motion analyzer circuitry 308, the virtual character motion generator circuitry 310, and/or the virtual character motion presenter circuitry 312 may form a portion of one or more of the processor 122, the I/O subsystem 126, and/or other components of the compute device 102. Additionally, in some embodiments, one or more of the illustrative components of the environment 300 may form a portion of another component and/or one or more of the illustrative components may be independent of one another. Further, in some embodiments, one or more of the components of the environment 300 may be embodied as virtualized hardware components or emulated architecture, which may be established and maintained by the processor 122 or other components of the compute device 102.

The virtual character identifier 302 is configured to identify a virtual character 140 that is to be customized to be moved in accordance with a motion model generated from a motion video as discussed further below. To do so, the virtual character identifier 302 includes a virtual character generator 322. In some embodiments, the virtual character generator 322 may generate or select an existing virtual character as the virtual character 140. In other embodiments, the virtual character generator 322 may generate a virtual character 140 based on an identification of the physical object 106 that is associated with the virtual character 140. To do so, in some embodiments, the virtual character generator 322 may receive identification data from the physical object 106 that identifies the virtual character 140, which may be stored in the data storage 170 of the physical object 106 as discussed above. Alternatively, the identification of the physical object 106 may be determined based on the visual pattern of the physical object 106 determined by the object identification sensor 134 of the compute device 102 or on the shape of the physical object 106 (e.g., via object recognition techniques applied to an image of the physical object 106). The virtual character generator 322 further includes a rigging generator 324 to generate a rigging of the virtual character 140. As discussed above, the rigging of the virtual character 140 defines a skeleton and joints of the virtual character 140. In some embodiments, the virtual character 140 includes the virtual rigging as part of the instantiation of the virtual character 140. Additionally, the virtual character 140 may include an associated default or predefined motion model that defines how the virtual rigging moves to move the virtual character 140.

The character tracker 304 is configured to track the virtual character 140 and/or the physical object 106. To do so, the character tracker 304 includes a path tracker 342 and, in some embodiments, a gait tracker 344. The path tracker 342 is configured to track a virtual motion path 142 of the virtual character 140 or a motion path 114 of the physical object 106 in the physical environment 112, depending on the embodiment. In embodiments in which the character tracker tracks the physical object 106, the gait tracker 334 is configured to track the motion of the physical object 106 as it is moved along the motion path 114. For example, the user may move the physical object 106 in hopping steps along the motion path 114. In such embodiments, as discussed below, the virtual character 140 may be moved along the virtual motion path 142 in accordance with a newly generated motion model that causes the movement of the virtual character 140 to mimic the movement of the physical object 106 (e.g., a hopping motion).

The motion determiner 306 is configured to determine a motion to be applied to the virtual character 140. To do so, the motion determiner 306 includes a motion query generator 362 and a motion video selector 370. The motion query generator 362 is configured to generate an online search query for motion videos of an animal. As discussed above, the motion videos may be embodied as any type of video that captures or depicts a motion of a corresponding animal. The motion query generator 362 generates the online search query for an online repository 104 of motion videos of animals to retrieve motion videos that matches the online search query. To do so, the motion query generator 362 may include a user interface 364, a virtual character-based querier 366, and/or physical object-based querier 368 to generate an online search query. In some embodiments, the user interface 364 is configured to receive an input query from the user. It should be appreciated that the input query may define an animal and may further specify characteristics of a motion of the animal to be depicted in motion videos (e.g., “a dog running”). In some embodiments, the input query may be very specific. For examples, the user may query for motion videos that depicts a baby monkey jumping up and down.

In some embodiments, the virtual character-based querier 366 may generate an online search query for motion videos of an animal based on the virtual character 140. In such embodiments, the virtual character 140 may depict a particular animal or creature. In other embodiments, the virtual character-based querier 366 may generate an online search query based on the virtual motion path of the virtual character 140. In embodiments in which the virtual character 140 is associated with a physical object 106, the physical object-based querier 368 may generate the online search query for motion videos of an animal based on the identification of the physical object 106. As discussed above, the identification of the physical object 106 may be determined from the identification data received from the physical object 106, based on a detected visual pattern of the physical object 106, based on an image of the physical object 106, and/or other data. Additionally or alternatively, the physical object-based querier 368 may generate an online search query based on the motion path 114 of the physical object 106. Additionally, in some embodiments, the online search query may be generated based on characteristics of a motion of the physical object 106 as the physical object 106 is moved along the motion path 114 (e.g., a jumping motion or speed of the movement of the physical object 106).

The motion video selector 370 is configured to present one or more motion videos of the search result of the online search query to the user and select a motion video from search result based on a user selection. To do so, the motion video selector 370 may include a user interfacer 372 to receive a selection of a motion video of the search result from the user.

The motion analyzer 308 is configured to analyze the selected motion video to generate a motion model for the virtual character 140 based on the motion of the animal depicted in the selected motion video. To do so, the motion analyzer 308 further includes the motion model generator 382. The motion model generator 382 is configured to generate a motion model for the animal depicted in the selected motion video. To do so, the motion model generator 382 further includes a rigging identifier 384 that is configured to generate a virtual rigging of the animal depicted in the selection motion video. The motion model generator 382 may utilize any suitable methodology to generate the virtual rigging as discussed above. Based on the defined virtual rigging and the motion of the an animal depicted in the motion video, the motion model generator 382 generates a motion model that causes the identified virtual rigging to move in a manner that matches or mimics the movement of the animal.

The virtual character motion generator 310 is configured to move the virtual rigging of the virtual character 140 based on a motion model generated for the virtual character 140. To do so, the virtual character motion generator 310 includes a motion modeler 374 that is configured to generate a new motion model for the virtual character 140 based on the motion model of the animal depicted in the selected motion video and the virtual riggings of the virtual character 140. As discussed above, the motion model of the animal is based on the determined motion of the virtual rigging of the animal depicted in the selected motion video. The motion modeler 374 is configured to apply the motion model for the animal to the virtual rigging of the virtual character 140 to generate a motion model for the virtual character 140 that is adapted to the virtual rigging of the virtual character 140. It should be appreciated that the motion modeler 374 may ignore or delete a portion of the virtual rigging of the animal if that portion of the virtual rigging of the animal does not correspond to any portion of the rigging of the virtual character 140. For example, if a virtual character 140 is a human and an animal depicted in the selected motion video is a monkey, the motion modeler 374 may ignore or delete a rigging of the tail of the monkey when generating a motion model for the virtual human character 140. The motion model for the virtual character 140 is applied to the virtual character 140 to cause the virtual rigging of the virtual character 140 to move in the similar manner as the virtual rigging of the animal. As a result, the virtual rigging of the virtual character 140 mimics the motion (e.g., the limb movements and posturing) of the corresponding virtual rigging of the animal depicted in the selected motion video.

The virtual character motion presenter 312 is configured to present the virtual character 140 in motion on the display 138 using the newly generated motion model for the virtual character 140. As discussed above, the motion model for the virtual character 140 is applied to the virtual rigging of the virtual character 140 to move the virtual rigging of the virtual character 140 in the similar manner as the motion of the corresponding virtual rigging of the animal depicted in the selected motion video. Accordingly, the virtual character motion presenter 312 presents the virtual character 140 to move along the virtual motion path 142 using the generated motion model for motion of the virtual character 1402. It should be appreciated that, as discussed above, in the embodiment where the virtual character 140 corresponds to a physical object 106 in a physical environment 112, the virtual motion path 142 corresponds to the motion path 114 of the physical object 106. In such embodiment, the virtual character 140 is moved along the virtual motion path 142 corresponding to the motion path 114 of the physical object 106 using the generated motion model for motion of the virtual character 140.

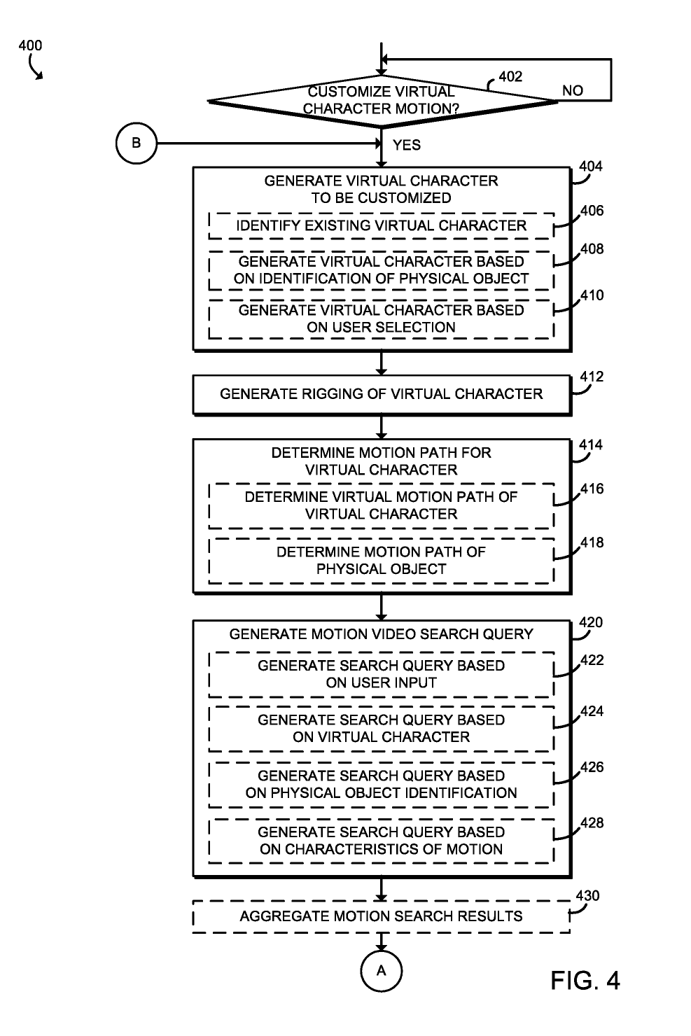

Referring now to FIG. 4, in use, the compute device 102 may execute a method 400 for generating a motion model for a virtual character 140. The method 400 begins with block 402, in which the compute device 102 determines whether to customize a virtual character motion. If the compute device 102 determines not to customize a virtual character motion, the method 400 loops back to block 402 to continue determining whether to customize a virtual character motion. If, however, the compute device 102 determines to customize a virtual character motion, the method 400 advances to block 404.

In block 404, the compute device 102 generates a virtual character to be customized. To do so, in some embodiments, the compute device 102 may identify an existing virtual character as indicated in block 406. Alternatively, in some embodiments, the compute device 102 may generate a virtual character based on an identification of a physical object 106 as indicated in block 408. For example, the identification data of the physical object 106 may indicate a predefined virtual character that is associated with the physical object 106. In other embodiments, the compute device 102 generates a virtual character based on a user selection as indicated in block 410. In such embodiments, the user may assign a virtual character that corresponds to the physical object 106.

In block 412, the compute device 102 generates a virtual rigging of the virtual character 140. As discussed above, the rigging of the virtual character 140 defines a skeleton (rigs) and joints of the virtual character 140 and is used to customize the motion of the virtual character 140. Additionally, in some embodiments, the virtual character may inherently include a virtual rigging as part of the virtual character model.

In block 414, the compute device 102 determines a motion path of the virtual character 140. To do so, in some embodiments, the compute device 102 may determine a virtual motion path of the virtual character 140 as indicated in block 416. For example, a user of the compute device 102 may move the virtual character 140 along a virtual motion path 142 in a virtual environment. Alternatively or additionally, the compute device 102 may determine a motion path of the physical object 106 that corresponds to the virtual character 140 to determine a motion path of the virtual character 140 as indicated in block 418. For example, the user may move the physical object 106 along the physical motion path 114 in a physical environment.

In block 420, the compute device 102 generates a motion video search query. As discussed above, the motion video search query is an online search query for motion videos of an animal. To do so, in block 422, the compute device 102 generates a search query based on a user input. For example, the user may define an animal and may further define a motion of the animal to be depicted in motion videos. Alternatively, in some embodiments, the compute device 102 may generate a search query based on the virtual character 140 as indicated in block 424. For example, the compute device 102 may determine an animal that is depicted by or associated with the virtual character 140. In other embodiments, the compute device 102 may generate a search query based on the identification of the physical object 106 as indicated in block 426. For example, the compute device 102 may determine an animal that is depicted by the physical object 106 or identification data received from the physical object 106.

Additionally or alternatively, in some embodiments in block 428, the compute device 102 may generate a search query based on characteristics of a motion. For example, in some embodiments, the compute device 102 may determine the characteristics of a motion of the virtual character 140 by determining a motion of the virtual character 140 along the virtual motion path 142. The characteristics of a motion of the virtual character 140 may be based on, but not limited to, how the user virtually moves and positions the virtual character 140, speed at which the user moves the virtual character 140, or action that the virtual character 140 takes along the virtual motion path 142. Alternatively, in other embodiments, the compute device 102 may determine the characteristics of a motion of the physical object 106 by determining a motion of the physical object 106 along the motion path 114. The characteristics of a motion of the physical object 106 may be based on, but not limited to, how the user physically moves and positions the physical object 106, speed at which the user moves the physical object 106, or action that the physical object 106 takes along the motion path 114.

In block 430, the compute device 102 may aggregate the motion search results and present to the user. For example, if multiple, independent remote motion repositories are queried, the compute device 102 may aggregate the multiple search results in block 430.

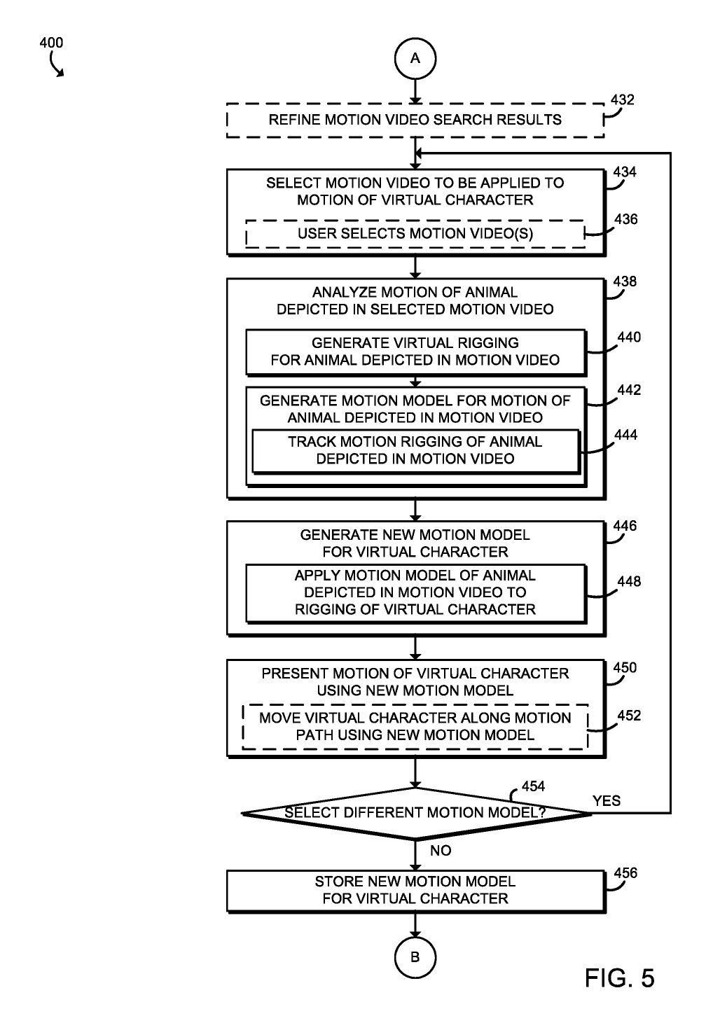

The method 400 subsequently advances to block 432 of FIG. 5, in which the compute device 102 may further refine the motion video search results. In some embodiments, the characteristics of the motion of the virtual character 140 or the physical object 106 may be used to refine or filter the motion video search results to only those motion videos that depicts a motion of the queried animal that has similar characteristics as the motion of the virtual character 140 or the physical object 106. For example, if the queried animal is a monkey and the user moved the physical object 106 up and down in a jumping motion along the motion path 114, the compute device 102 may refine the motion video search results to those motion video that depicts the monkey jumping up and down. It should be appreciated that, as discussed in block 428, the characteristics of the motion may be initially considered when generating a search query. Additionally, in some embodiments, the search results may be refined based on selections received from the user.

In block 434, the compute device 102 selects a motion video from the search results to be applied to the motion of the virtual character 140. In some embodiments, the selection of the motion video may be based on a user selection as indicated in block 436. It should be appreciated that the user may select more than one motion videos to be implemented in different scenes.

In block 438, the compute device 102 analyzes the motion of the animal depicted in the selected motion video. To do so, the compute device 102 generates a virtual rigging for the animal depicted in the selected motion video as indicated in block 440. The compute device 102 then generates a motion model for the motion of the animal depicted in the selected motion video as indicated in block 442. To generate a motion model for the motion of the animal, the compute device 102 determines the motion of the virtual rigging of the animal that tracks the motion of the animal depicted in the selected motion video as indicated in block 444.

In block 446, the compute device 102 generates a new motion model for the virtual character 140. To do so, the compute device 102 applies the motion model of the animal depicted in the motion video to the rigging of the virtual character 140. Specifically, the compute device 102 applies the motion model for the animal to the virtual rigging of the virtual character 140 to generate a motion model for the virtual character 140 that is adapted to the virtual rigging of the virtual character 140. As discussed above, in some embodiments, the compute device 102 may ignore or delete a portion of the virtual rigging of the animal if that portion of the virtual rigging of the animal does not corresponds to any portion of the rigging of the virtual character 140.

In block 450, the compute device 102 presents the motion of the virtual character 140 using the new motion model to cause the virtual character 140 to mimic the motion of the animal depicted in the selection motion video. In some embodiments, the compute device 102 moves the virtual character 140 along the virtual motion path using the new motion model 452. It should be appreciated that, as discussed above, in the embodiment where the virtual character 140 corresponds to a physical object 106 in a physical environment 112, the virtual motion path 142 corresponds to the motion path 114 of the physical object 106. In such embodiment, the virtual character 140 is moved along the virtual motion path 142 corresponding to the motion path 114 of the physical object 106 using the generated motion model for motion of the virtual character 140.

In block 454, the compute device 102 determines whether to select a different motion model. For example, the user may determine to select a different motion model after watching the motion of the virtual character 140 generated using the new motion model for the virtual character 140 presented in block 450. If the compute device 102 determines to select a different motion model, the method 400 loops back to block 434 to select a new motion video to generate a new motion model for the virtual character 140. If, however, the compute device 102 determines not to select a different motion mode, the method 400 advances to block 456 in which the compute device 102 stores the new motion model for the virtual character 140 and loops back to block 404 to continue generating the same or different virtual character to be customized.

### EXAMPLES

Illustrative examples of the technologies disclosed herein are provided below. An embodiment of the technologies may include any one or more, and any combination of, the examples described below.

Example 1 includes a compute device for generating a motion model for a virtual character. The compute device includes a motion determiner to (i) generate an online search query for motion videos of an animal, wherein the motion videos depict a corresponding animal in motion and (ii) select a motion video from a search result of the online search query; a motion analyzer to analyze the selected motion video to generate a motion model for the virtual character based on the motion of the animal depicted in the selected motion video; and a virtual character motion presenter to present, on a display, the virtual character in motion using the generated motion model for the motion of the virtual character.

Example 2 includes the subject matter of Example 1, and wherein to analyze the selected motion video comprises to: generate a virtual rigging for the animal depicted in the selected motion video; and determine a motion of the virtual rigging of the animal that tracks the motion of the animal depicted in the selected motion video.

Example 3 includes the subject matter of Example 1 or 2, and wherein to analyze the selected motion video comprises to generate the motion model for the virtual character based on the motion of the virtual rigging of the animal depicted in the selected motion video.

Example 4 includes the subject matter of any of Examples 1-3, and wherein to present the virtual character in motion comprises to move a virtual rigging of the virtual character based on the determined motion of the virtual rigging of the animal depicted in the selected motion video.

Example 5 includes the subject matter of any of Examples 1-4, and wherein to present the virtual character in motion comprises to move a virtual rigging of the virtual character based on the generated motion model.

Example 6 includes the subject matter of any of Examples 1-5, and wherein to present the virtual character in motion comprises to generate a new motion model for the virtual character based on a virtual rigging of the virtual character and the generated motion model.

Example 7 includes the subject matter of any of Examples 1-6, and further comprising an object tracker to track a motion path of a physical object corresponding to the virtual character, wherein to present the virtual character in motion comprises to move the virtual character along a virtual motion path corresponding to the motion path of the physical object using the generated motion model for motion of the virtual character while moving along the virtual motion path.

Example 8 includes the subject matter of any of Examples 1-7, and wherein to generate the online search query comprises to generate an online search query for motion videos of an animal based on the motion path of the physical object.

Example 9 includes the subject matter of any of Examples 1-8, and wherein to generate the online search query comprises to generate an online search query for motion videos of an animal based on characteristics of a motion of the physical object as the physical object is moved along the motion path.

Example 10 includes the subject matter of any of Examples 1-9, and further comprising an object tracker to track a virtual motion path of the virtual character, wherein to present the virtual character in motion comprises to move the virtual character along the virtual motion path using the generated motion model for motion of the virtual character while moving along the virtual motion path.

Example 11 includes the subject matter of any of Examples 1-10, and wherein to generate the online search query comprises to generate an online search query for motion videos of an animal based on the virtual motion path of the virtual character.

Example 12 includes the subject matter of any of Examples 1-11, and wherein to generate the online search query comprises to generate an online search query for an online repository of motion videos of animals.

Example 13 includes the subject matter of any of Examples 1-12, and wherein to generate the online search query comprises to receive an input query from a user of the compute device, wherein the input query defines the animal.

Example 14 includes the subject matter of any of Examples 1-13, and wherein to generate the online search query comprises to generate the search query based on an identification of a physical object corresponding to the virtual character.

Example 15 includes the subject matter of any of Examples 1-14, and wherein to generate the online search query based on the identification of the physical object comprises to receive identification data from the physical object that identifies the virtual character or the animal.

Example 16 includes the subject matter of any of Examples 1-15, and wherein to generate the online search query based on the identification of the physical object comprises to: detect a visual pattern of the physical object; and determine the identification of the physical object based on the visual pattern, wherein the identification of the physical object identifies the virtual character or the animal.

Example 17 includes the subject matter of any of Examples 1-16, and wherein to select the motion video comprises to: present a plurality of motion videos of the search result to a user; and receive a selection of a motion video of the plurality of motion videos from the user.

Example 18 includes the subject matter of any of Examples 1-17, and further comprising an object identifier to generate the virtual character based on an identification of a physical object corresponding to the virtual character.

Example 19 includes the subject matter of any of Examples 1-18, and wherein to generate the virtual character based on the identification of the physical object comprises to receive identification data from the physical object that identifies the virtual character.

Example 20 includes the subject matter of any of Examples 1-19, and wherein to generate the virtual character based on the identification of the physical object comprises to detect a visual pattern of the physical object; and determine the identification of the physical object based on the visual pattern, wherein the identification of the physical object identifies the virtual character.

Example 21 includes a method for generating a motion model for a virtual character, the method comprising: generating, by a compute device, an online search query for motion videos of an animal, wherein the motion videos depict a corresponding animal in motion; selecting, by the compute device, a motion video from a search result of the online search query; analyzing, by the compute device, the selected motion video to generate a motion model for the virtual character based on the motion of the animal depicted in the selected motion video; and presenting, on a display and by the compute device, the virtual character in motion using the generated motion model for the motion of the virtual character.

Example 22 includes the subject matter of Example 21, and wherein analyzing the selected motion video comprises generating, by the compute device, a virtual rigging for the animal depicted in the selected motion video; and determining, by the compute device, a motion of the virtual rigging of the animal that tracks the motion of the animal depicted in the selected motion video.

Example 23 includes the subject matter of Example 21 or 22, and wherein analyzing the selected motion video comprises generating the motion model for the virtual character based on the motion of the virtual rigging of the animal depicted in the selected motion video.

Example 24 includes the subject matter of any of Examples 21-23, and wherein presenting the virtual character in motion comprises moving a virtual rigging of the virtual character based on the determined motion of the virtual rigging of the animal depicted in the selected motion video.

Example 25 includes the subject matter of any of Examples 21-24, and wherein presenting the virtual character in motion comprises moving a virtual rigging of the virtual character based on the generated motion model.

Example 26 includes the subject matter of any of Examples 21-25, and wherein presenting the virtual character in motion comprises generating, by the compute device, a new motion model for the virtual character based on a virtual rigging of the virtual character and the generated motion model.

Example 27 includes the subject matter of any of Examples 21-26, and further comprising tracking, by the compute device, a motion path of a physical object corresponding to the virtual character, wherein presenting the virtual character in motion comprises moving the virtual character along a virtual motion path corresponding to the motion path of the physical object using the generated motion model for motion of the virtual character while moving along the virtual motion path.

Example 28 includes the subject matter of any of Examples 21-27, and wherein generating the online search query comprises generating an online search query for motion videos of an animal based on the motion path of the physical object.

Example 29 includes the subject matter of any of Examples 21-28, and wherein generating the online search query comprises generating an online search query for motion videos of an animal based on characteristics of a motion of the physical object as the physical object is moved along the motion path.

Example 30 includes the subject matter of any of Examples 21-29, and further comprising tracking a virtual motion path of the virtual character, wherein presenting the virtual character in motion comprises moving the virtual character along the virtual motion path using the generated motion model for motion of the virtual character while moving along the virtual motion path.

Example 31 includes the subject matter of any of Examples 21-30, and wherein generating the online search query comprises generating an online search query for motion videos of an animal based on the virtual motion path of the virtual character.

Example 32 includes the subject matter of any of Examples 21-31, and wherein generating the online search query comprises generating an online search query for an online repository of motion videos of animals.

Example 33 includes the subject matter of any of Examples 21-32, and wherein generating the online search query comprises receiving, by the compute device, an input query from a user of the compute device, wherein the input query defines the animal.

Example 34 includes the subject matter of any of Examples 21-33, and wherein generating the online search query comprises generating the search query based on an identification of a physical object corresponding to the virtual character.

Example 35 includes the subject matter of any of Examples 21-34, and wherein generating the online search query based on the identification of the physical object comprises receiving identification data from the physical object that identifies the virtual character or the animal.

Example 36 includes the subject matter of any of Examples 21-35, and wherein generating the online search query based on the identification of the physical object comprises detecting, by the compute device, a visual pattern of the physical object; and determining, by the compute device, the identification of the physical object based on the visual pattern, wherein the identification of the physical object identifies the virtual character or the animal.

Example 37 includes the subject matter of any of Examples 21-36, and wherein selecting the motion video comprises: presenting, by the compute device, a plurality of motion videos of the search result to a user; and receiving, by the compute device, a selection of a motion video of the plurality of motion videos from the user.

Example 38 includes the subject matter of any of Examples 21-37, and further comprising generating, by the compute device, the virtual character based on an identification of a physical object corresponding to the virtual character.

Example 39 includes the subject matter of any of Examples 21-38, and wherein generating the virtual character based on the identification of the physical object comprises receiving identification data from the physical object that identifies the virtual character.

Example 40 includes the subject matter of any of Examples 21-39, and wherein generating the virtual character based on the identification of the physical object comprises: detecting, by the compute device, a visual pattern of the physical object; and determining, by the compute device, the identification of the physical object based on the visual pattern, wherein the identification of the physical object identifies the virtual character.

Example 41 includes one or more computer-readable storage media comprising a plurality of instructions that, when executed by a compute device, cause the compute device to perform the method of any of Examples 21-40.

Example 42 includes a compute device for generating a motion model for a virtual character, the compute device comprising means for generating an online search query for motion videos of an animal, wherein the motion videos depict a corresponding animal in motion; means for selecting a motion video from a search result of the online search query; means for analyzing the selected motion video to generate a motion model for the virtual character based on the motion of the animal depicted in the selected motion video; and means for presenting, on a display, the virtual character in motion using the generated motion model for the motion of the virtual character.

Example 43 includes the subject matter of Example 42, and wherein the means for analyzing the selected motion video comprises: means for generating a virtual rigging for the animal depicted in the selected motion video; and means for determining a motion of the virtual rigging of the animal that tracks the motion of the animal depicted in the selected motion video.

Example 44 includes the subject matter of Example 42 or 43, and wherein the means for analyzing the selected motion video comprises means for generating the motion model for the virtual character based on the motion of the virtual rigging of the animal depicted in the selected motion video.

Example 45 includes the subject matter of any of Examples 42-44, and wherein the means for presenting the virtual character in motion comprises means for moving a virtual rigging of the virtual character based on the determined motion of the virtual rigging of the animal depicted in the selected motion video.

Example 46 includes the subject matter of any of Examples 42-45, and wherein the means for presenting the virtual character in motion comprises means for moving a virtual rigging of the virtual character based on the generated motion model.

Example 47 includes the subject matter of any of Examples 42-46, and wherein the means for presenting the virtual character in motion comprises means for generating a new motion model for the virtual character based on a virtual rigging of the virtual character and the generated motion model.

Example 48 includes the subject matter of any of Examples 42-47, and further comprising means for tracking a motion path of a physical object corresponding to the virtual character, wherein the means for presenting the virtual character in motion comprises means for moving the virtual character along a virtual motion path corresponding to the motion path of the physical object using the generated motion model for motion of the virtual character while moving along the virtual motion path.

Example 49 includes the subject matter of any of Examples 42-48, and wherein the means for generating the online search query comprises means for generating an online search query for motion videos of an animal based on the motion path of the physical object.

Example 50 includes the subject matter of any of Examples 42-49, and wherein the means for generating the online search query comprises means for generating an online search query for motion videos of an animal based on characteristics of a motion of the physical object as the physical object is moved along the motion path.

Example 51 includes the subject matter of any of Examples 42-50, and further comprising means for tracking a virtual motion path of the virtual character, wherein the means for presenting the virtual character in motion comprises means for moving the virtual character along the virtual motion path using the generated motion model for motion of the virtual character while moving along the virtual motion path.

Example 52 includes the subject matter of any of Examples 42-51, and wherein the means for generating the online search query comprises means for generating an online search query for motion videos of an animal based on the virtual motion path of the virtual character.

Example 53 includes the subject matter of any of Examples 42-52, and wherein the means for generating the online search query comprises means for generating an online search query for an online repository of motion videos of animals.

Example 54 includes the subject matter of any of Examples 42-53, and wherein the means for generating the online search query comprises means for receiving an input query from a user of the compute device, wherein the input query defines the animal.

Example 55 includes the subject matter of any of Examples 42-54, and wherein the means for generating the online search query comprises means for generating the search query based on an identification of a physical object corresponding to the virtual character.

Example 56 includes the subject matter of any of Examples 42-55, and wherein the means for generating the online search query based on the identification of the physical object comprises means for receiving identification data from the physical object that identifies the virtual character or the animal.

Example 57 includes the subject matter of any of Examples 42-56, and wherein the means for generating the online search query based on the identification of the physical object comprises: means for detecting a visual pattern of the physical object; and means for determining the identification of the physical object based on the visual pattern, wherein the identification of the physical object identifies the virtual character or the animal.

Example 58 includes the subject matter of any of Examples 42-57, and wherein the means for selecting the motion video comprises: means for presenting a plurality of motion videos of the search result to a user; and means for receiving a selection of a motion video of the plurality of motion videos from the user.

Example 59 includes the subject matter of any of Examples 42-58, and further comprising means for generating the virtual character based on an identification of a physical object corresponding to the virtual character.

Example 60 includes the subject matter of any of Examples 42-59, and wherein the means for generating the virtual character based on the identification of the physical object comprises means for receiving identification data from the physical object that identifies the virtual character.

Example 61 includes the subject matter of any of Examples 42-60, and wherein the means for generating the virtual character based on the identification of the physical object comprises: means for detecting a visual pattern of the physical object; and means for determining the identification of the physical object based on the visual pattern, wherein the identification of the physical object identifies the virtual character.

1. A compute device for generating a motion model for a virtual character, the compute device comprising:
a motion determiner to (i) generate an online search query for motion videos of an animal, wherein the motion videos depict a corresponding animal in motion and (ii) select a motion video from a search result of the online search query;
a motion analyzer to analyze the selected motion video to generate a motion model for the virtual character based on the motion of the animal depicted in the selected motion video; and
a virtual character motion presenter to present, on a display, the virtual character in motion using the generated motion model for the motion of the virtual character.

2. The compute device of claim 1, wherein to analyze the selected motion video comprises to:
generate a virtual rigging for the animal depicted in the selected motion video; and
determine a motion of the virtual rigging of the animal that tracks the motion of the animal depicted in the selected motion video.

3. The compute device of claim 2, wherein to analyze the selected motion video comprises to generate the motion model for the virtual character based on the motion of the virtual rigging of the animal depicted in the selected motion video.

4. The compute device of claim 2, wherein to present the virtual character in motion comprises to move a virtual rigging of the virtual character based on the determined motion of the virtual rigging of the animal depicted in the selected motion video.

5. The compute device of claim 1, wherein to present the virtual character in motion comprises to move a virtual rigging of the virtual character based on the generated motion model.

6. The compute device of claim 1, wherein to present the virtual character in motion comprises to generate a new motion model for the virtual character based on a virtual rigging of the virtual character and the generated motion model.

7. The compute device of claim 1, further comprising an object tracker to track a motion path of a physical object corresponding to the virtual character,
wherein to present the virtual character in motion comprises to move the virtual character along a virtual motion path corresponding to the motion path of the physical object using the generated motion model for motion of the virtual character while moving along the virtual motion path.

8. The compute device of claim 7, wherein to generate the online search query comprises to generate an online search query for motion videos of an animal based on characteristics of a motion of the physical object as the physical object is moved along the motion path.

9. The compute device of claim 1, wherein to generate the online search query comprises to generate the search query based on an identification of a physical object corresponding to the virtual character.

10. A method for generating a motion model for a virtual character, the method comprising:
generating, by a compute device, an online search query for motion videos of an animal, wherein the motion videos depict a corresponding animal in motion;
selecting, by the compute device, a motion video from a search result of the online search query;
analyzing, by the compute device, the selected motion video to generate a motion model for the virtual character based on the motion of the animal depicted in the selected motion video; and
presenting, on a display and by the compute device, the virtual character in motion using the generated motion model for the motion of the virtual character.

11. The method of claim 10, wherein analyzing the selected motion video comprises:
generating, by the compute device, a virtual rigging for the animal depicted in the selected motion video; and
determining, by the compute device, a motion of the virtual rigging of the animal that tracks the motion of the animal depicted in the selected motion video.

12. The method of claim 11, wherein analyzing the selected motion video comprises generating the motion model for the virtual character based on the motion of the virtual rigging of the animal depicted in the selected motion video.

13. The method of claim 11, wherein presenting the virtual character in motion comprises moving a virtual rigging of the virtual character based on the determined motion of the virtual rigging of the animal depicted in the selected motion video.

14. The method of claim 10, wherein presenting the virtual character in motion comprises generating, by the compute device, a new motion model for the virtual character based on a virtual rigging of the virtual character and the generated motion model.

15. The method of claim 10, further comprising tracking, by the compute device, a motion path of a physical object corresponding to the virtual character,
wherein presenting the virtual character in motion comprises moving the virtual character along a virtual motion path corresponding to the motion path of the physical object using the generated motion model for motion of the virtual character while moving along the virtual motion path.

16. The method of claim 15, wherein generating the online search query comprises generating an online search query for motion videos of an animal based on characteristics of a motion of the physical object as the physical object is moved along the motion path.

17. The method of claim 10, wherein generating the online search query comprises generating the search query based on an identification of a physical object corresponding to the virtual character.

18. One or more computer-readable storage media comprising a plurality of instructions that, when executed by a compute device, cause the compute device to:
generate an online search query for motion videos of an animal, wherein the motion videos depict a corresponding animal in motion;
select a motion video from a search result of the online search query;
analyze the selected motion video to generate a motion model for the virtual character based on the motion of the animal depicted in the selected motion video; and
present, on a display, the virtual character in motion using the generated motion model for the motion of the virtual character.

19. The one or more computer-readable storage media of claim 18, wherein to analyze the selected motion video comprises to:
generate a virtual rigging for the animal depicted in the selected motion video; and
determine a motion of the virtual rigging of the animal that tracks the motion of the animal depicted in the selected motion video.

20. The one or more computer-readable storage media of claim 19, wherein to analyze the selected motion video comprises to generate the motion model for the virtual character based on the motion of the virtual rigging of the animal depicted in the selected motion video.

21. The one or more computer-readable storage media of claim 19, wherein to present the virtual character in motion comprises to move a virtual rigging of the virtual character based on the determined motion of the virtual rigging of the animal depicted in the selected motion video.

22. The one or more computer-readable storage media of claim 18, wherein to present the virtual character in motion comprises to generate a new motion model for the virtual character based on a virtual rigging of the virtual character and the generated motion model.

23. The one or more computer-readable storage media of claim 18, wherein the plurality of instructions, when executed, further cause the compute device to track a motion path of a physical object corresponding to the virtual character,
wherein to present the virtual character in motion comprises to move the virtual character along a virtual motion path corresponding to the motion path of the physical object using the generated motion model for motion of the virtual character while moving along the virtual motion path.

24. The one or more computer-readable storage media of claim 23, wherein to generate the online search query comprises to generate an online search query for motion videos of an animal based on characteristics of a motion of the physical object as the physical object is moved along the motion path.

25. The one or more computer-readable storage media of claim 18, wherein to generate the online search query comprises to generate the search query based on an identification of a physical object corresponding to the virtual character.
